(19) United States
(12) Patent Application Publication
(10) Pub. No.: US 2006/0078053 A1
(43) Pub. Date: Apr. 13, 2006

(54) Method for encoding and decoding video signals

(76) Inventors: Seung Wook Park, Sungnam-si (KR); Ji Ho Park, Sungnam-si (KR); Byeong Moon Jeon, Sungnam-si (KR)

Correspondence Address: HARNESS, DICKEY & PIERCE, P.L.C., P.O. BOX 8910, RESTON, VA, 20195, US

(21) Appl. No.: 11/243,991

(22) Filed: Oct. 6, 2005

Related U.S. Application Data
(60) Provisional application No. 60/616,230, filed on Oct. 7, 2004.

(30) Foreign Application Priority Data
Feb. 23, 2005 (KR) 10-2005-0014852

(51) Int. Cl. H04N 11/04; H04N 7/12; H04B 1/66; H04N 11/02

(52) U.S. Cl. 375/240.24; 375/240.12

(57) ABSTRACT

In one embodiment of the method of decoding an encoded video signal including a first frame sequence and a second frame sequence by inverse motion compensated temporal filtering, one or more macroblocks in at least one frame in the second frame sequence associated with a current macroblock in a current frame in the first frame sequence are determined based on information included in a header of the current macroblock. The determined one or more macroblocks are decoded based on the current macroblock and the information, and the current macroblock is decoded based on the decoded one or more macroblocks.

### DOMESTIC PRIORITY INFORMATION

This application claims priority under 35 U.S.C. §119 on U.S. provisional application Ser. No. 60/616,230, filed Oct. 7, 2004; the entire contents of which are hereby incorporated by reference.

### BACKGROUND OF THE INVENTION

1. Field of the Invention

The present invention relates to a method for encoding and decoding video signals.

2. Description of the Related Art

A number of standards have been suggested for digitizing video signals. One well-known standard is MPEG, which has been adopted for recording movie content, etc., on recording media such as DVDs and is now in widespread use. Another standard is H.264, which is expected to be used as a standard for high-quality TV broadcast signals in the future.

While TV broadcast signals require high bandwidth, it is difficult to allocate such high bandwidth for the type of wireless transmissions/receptions performed by mobile phones and notebook computers, for example. Thus, video compression standards for use with mobile devices must have high video signal compression efficiencies.

Such mobile devices have a variety of processing and presentation capabilities so that a variety of compressed video data forms must be prepared. This indicates that the same video source must be provided in a variety of forms corresponding to a variety of combinations of variables such as the number of frames transmitted per second, resolution, the number of bits per pixel, etc. This imposes a great burden on content providers.

In view of the above, content providers prepare high-bitrate compressed video data for each source video and perform, when receiving a request from a mobile device, a process of decoding compressed video and encoding it back into video data suited to the video processing capabilities of the mobile device before providing the requested video to the mobile device. However, this method entails a transcoding procedure including decoding and encoding processes, and causes some time delay in providing the requested data to the mobile device. The transcoding procedure also requires complex hardware and algorithms to cope with the wide variety of target encoding formats.

A Scalable Video Codec (SVC) has been developed in an attempt to overcome these problems. This scheme encodes video into a sequence of pictures with the highest image quality while guaranteeing a certain level of image quality of the video when using part of the encoded picture sequence (specifically, a partial sequence of frames intermittently selected from the total sequence of frames).

Motion Compensated Temporal Filtering (MCTF) is an encoding scheme that has been suggested for use in the scalable video codec. However, the MCTF scheme requires a high compression efficiency (i.e., a high coding efficiency) for reducing the number of bits transmitted per second since it is highly likely that it will be applied to mobile communication where bandwidth is limited, as described above.

In MCTF, which is a Motion Compensation (MC) encoding method, it is beneficial to find overlapping parts (e.g., temporally correlated parts) in a video sequence. However, non-overlapping parts (e.g., unconnected or uncorrelated areas) may be present in a previous and a next frame. Such unconnected areas may cause ghost artifacts in the encoded frames produced by MCTF. The unconnected areas may also cause compressed frames generated by MCTF to have large residual energy, resulting in a reduction in coding gain and/or efficiency.

### SUMMARY OF THE INVENTION

The present invention relates to encoding and decoding a video signal by motion compensated temporal filtering (MCTF).

In one embodiment of the method of decoding an encoded video signal including a first frame sequence and a second frame sequence by inverse motion compensated temporal filtering, one or more macroblocks in at least one frame in the second frame sequence associated with a current macroblock in a current frame in the first frame sequence are determined based on information included in a header of the current macroblock. The determined one or more macroblocks are decoded based on the current macroblock and the information, and the current macroblock is decoded based on the decoded one or more macroblocks.

In one embodiment, each frame in the second frame sequence including one of the determined macroblocks is adjacent to the current frame in the first frame sequence in the decoded video signal. For example, if the determining step determines, based on the information, that one macroblock in a frame of the second frame sequence is associated with the current macroblock, the frame in the second frame sequence is one of prior to and subsequent to the current frame in the decoded video signal. As another example, if the determining step determines, based on the information, that first and second macroblocks in at least one frame of the second frame sequence are associated with the current macroblock, the first and second macroblocks are one of (1) both in a frame of the second frame sequence that is prior to the current frame in the decoded video signal, (2) both in a frame of the second frame sequence that is subsequent to the current frame in the decoded video signal, and (3) the first macroblock is in a frame of the second frame sequence that is prior to the current frame in the decoded video signal and the second macroblock is in a frame in the second frame sequence that is subsequent to the current frame in the decoded video signal.

In one embodiment, the information indicates an encoding mode of the current macroblock. In another embodiment, the information indicates a number of the macroblocks in the second frame sequence associated with the current macroblock and a direction of each macroblock in the second frame second associated with the current macroblock.

In one embodiment of a method of encoding a video signal by motion compensated temporal filtering, one or more macroblocks in at least one frame adjacent to a frame including a current macroblock are determined. The current macroblock is encoded based on the determined one or more macroblocks to form a first sequence of frames in the encoded video signal. The determined one or more macroblocks are encoded based on the encoded current macroblock to form a second sequence of frames in the encoded video signal. Information is added to a header of the encoded current macroblock indicating the determined one or more macroblocks associated with the encoded current macroblock.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a block diagram of a video signal encoding device to which a scalable video signal compression method according to the present invention is applied;

FIG. 2 is a block diagram of a filter that performs video estimation/prediction and update operations in the MCTF encoder shown in FIG. 1;

FIG. 3 illustrates various macroblock modes according to an embodiment of the present invention;

FIG. 4 is a block diagram of a device for decoding a data stream, encoded by the device of FIG. 1, according to an example embodiments of the present invention; and

FIG. 5 is a block diagram of an inverse filter that performs inverse prediction and update operations in the MCTF decoder shown in FIG. 4 according to an example embodiments of the present invention.

### DETAILED DESCRIPTION OF EXAMPLE EMBODIMENTS

Example embodiments of the present invention will now be described in detail with reference to the accompanying drawings.

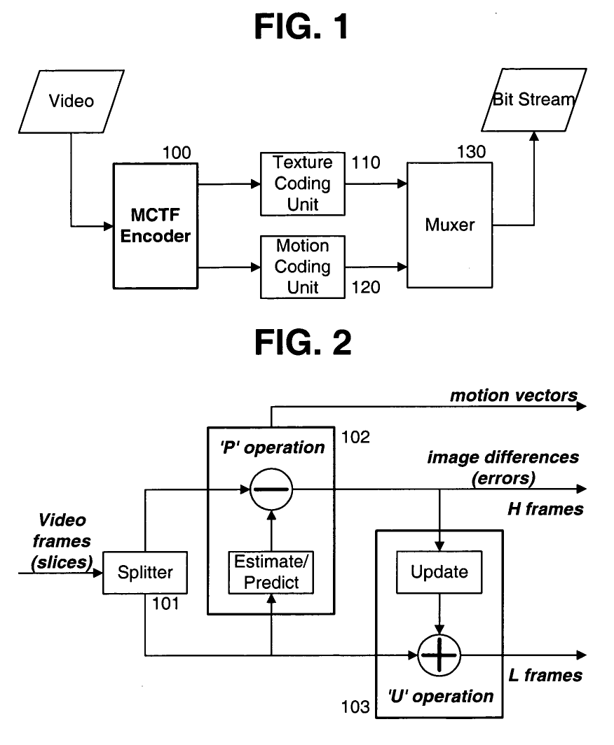

FIG. 1 is a block diagram of a video signal encoding device to which a scalable video signal compression method according to the present invention is applied.

The video signal encoding device shown in FIG. 1 comprises an MCTF encoder 100, a texture coding unit 110, a motion coding unit 120, and a muxer (or multiplexer) 130. The MCTF encoder 100 encodes an input video signal in units of macroblocks according to an MCTF scheme, and generates suitable management information. The texture coding unit 110 converts data of encoded macroblocks into a compressed bitstream. The motion coding unit 120 codes motion vectors of image blocks obtained by the MCTF encoder 100 into a compressed bitstream according to a specified scheme. The muxer 130 encapsulates the output data of the texture coding unit 110 and the output vector data of the motion coding unit 120 into a set format. The muxer 130 multiplexes the encapsulated data into a set transmission format and outputs a data stream.

The MCTF encoder 100 performs prediction operations such as motion estimation (ME) and motion compensation (MC) on each macroblock of a video frame, and also performs an update operation in such a manner that an image difference of the macroblock from a corresponding macroblock in a neighbor frame is added to the corresponding macroblock. FIG. 2 is a block diagram of a filter for carrying out these operations.

As shown in FIG. 2, the filter includes a splitter 101, an estimator/predictor 102, and an updater 103. The splitter 101 splits an input video frame sequence into earlier and later frames in pairs of successive frames (for example, into odd and even frames). The estimator/predictor 102 performs motion estimation and/or prediction operations on each macroblock in an arbitrary frame in the frame sequence. As described in more detail below, the estimator/predictor 102 searches for a reference block of each macroblock of the arbitrary frame in neighbor frames prior to and/or subsequent to the arbitrary frame and calculates an image difference (i.e., a pixel-to-pixel difference) of each macroblock from the reference block and a motion vector between each macroblock and the reference block. The updater 103 performs an update operation on a macroblock, whose reference block has been found, by normalizing the calculated image difference of the macroblock from the reference block and adding the normalized difference to the reference block. The operation carried out by the updater 103 is referred to as a ‘U’ operation, and a frame produced by the ‘U’ operation is referred to as an ‘L’ (low) frame.

The filter of FIG. 2 may perform its operations on a plurality of slices simultaneously and in parallel, which are produced by dividing a single frame, instead of performing its operations in units of frames. In the following description of the embodiments, the term ‘frame’ is used in a broad sense to include a ‘slice’.

The estimator/predictor 102 divides each of the input video frames into macroblocks of a set size. For each macroblock, the estimator/predictor 102 searches for a block, whose image is most similar to that of each divided macroblock, in neighbor frames prior to and/or subsequent to the input video frame through MC/ME operations. That is, the estimator/predictor 102 searches for a macroblock having the highest temporal correlation with the target macroblock. A block having the most similar image to a target image block has the smallest image difference from the target image block. The image difference of two image blocks is defined, for example, as the sum or average of pixel-to-pixel differences of the two image blocks. Accordingly, of macroblocks in a previous/next neighbor frame having a threshold pixel-to-pixel difference sum (or average) or less from a target macroblock in the current frame, a macroblock having the smallest difference sum (or average) from the target macroblock is referred to as a reference block.

If only one macroblock in the previous/next neighbor frame has the threshold image difference or less from the target macroblock in the current frame, the macroblock is selected as the reference block.

If two or more macroblocks in the previous/next neighbor frame have the threshold image difference or less from the target macroblock in the current frame, two or more reference blocks may be selected from these macroblocks. For example, if two reference blocks, one having the smallest image difference and the other having the second smallest image difference, are selected, the two reference blocks may both be present in a frame or frames prior to the current frame, may both be present in a frame or frames subsequent to the current frame, or one may be present in a prior frame and the other present in a subsequent frame.

A macroblock, for which two reference blocks in the prior frame are selected, is assigned a forward 2 (Fwd2) mode. Assignment or indication of this mode is achieved, for example, by adding mode information to the encoded macroblock in the encoded video signal as described in more detail below. A macroblock, for which two reference blocks in the subsequent frame are selected, is assigned a backward 2 (Bwd2) mode. The mode information for each mode will be different from the other modes so that upon decoding, the different modes may be discriminated.

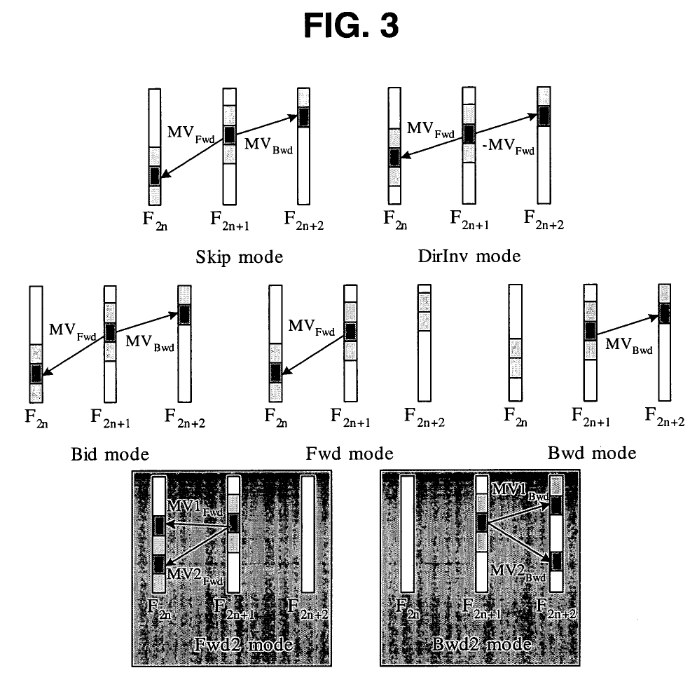

FIG. 3 illustrates various macroblock modes according to an embodiment of the present invention. The estimator/predictor 102 assigns a block mode value indicating a skip mode to the current macroblock if the motion vector of the current macroblock with respect to its reference block can be derived from motion vectors of neighbor or adjacent macroblocks, for example, if the average of motion vectors of left and top macroblocks can be regarded as the motion vector of the current macroblock. If the current macroblock is assigned a skip mode, no motion vector is provided to the motion coding unit 120 since the decoder can sufficiently derive the motion vector of the current macroblock.

The current macroblock is assigned a bidirectional (Bid) mode if two reference blocks of the current macroblock are respectively present in the prior and subsequent frames. The current macroblock is assigned an inverse direction (dirInv) mode if the two motion vectors have the same magnitude in opposite directions. The current macroblock is assigned a forward (Fwd) mode if the reference block of the current macroblock is present only in the prior frame. The current macroblock is assigned a backward (Bwd) mode if the reference block of the current macroblock is present only in the subsequent frame.

In addition, the current macroblock is assigned a forward 2 (Fwd2) mode if two reference blocks of the current macroblock are present in the prior frame. The current macroblock is assigned a backward 2 (Bwd2) mode if two reference blocks of the current macroblock are present in the subsequent frame.

If the reference block is found, the estimator/predictor 102 calculates and outputs a motion vector from the current block to the reference block, and also calculates and outputs differences of pixel values of the current block (1) from pixel values of the reference block, which is present in either the prior frame or the subsequent frame, or (2) from average pixel values of the two reference blocks, which are both present in prior frame(s), both present in subsequent frame(s) or respectively present in a prior frame and a subsequent frame.

Such an operation of the estimator/predictor 102 is referred to as a ‘P’ operation. A frame having an image difference, which the estimator/predictor 102 produces via the P operation, is referred to as a high or ‘H’ frame since this frame has high frequency components of the video signal.

Via the above procedure, each macroblock is assigned one of the various modes shown in FIG. 3, and a corresponding motion vector value is transmitted to the motion coding unit 120. The MCTF encoder 100 records or adds the block mode information at a specific position in a header area of the current macroblock. The muxer 130 combines the macroblock data and the header area and converts the combined data into a transmission format. If up to two reference blocks are selected according to an embodiment of the present invention, 7 macroblock modes are present for the macroblock, and the mode information may be recorded in a 3-bit information field in the header of the current macroblock.

According to the present invention, additional block modes (for example, the forward 2 mode and the backward 2 mode), in which two or more reference blocks are present in an adjacent frame, are assigned to the macroblock as describe above, so that it is possible to reduce the occurrence of unconnected areas discussed in the related art and also to increase coding gain.

The mode information of the macroblock may also be expressed in other ways. For example, the mode information field (mode) may be set to indicate the number of reference blocks and indicate the direction of each reference block. These indicators may be fields, an number information field and direction information field, in the header of a macroblock. For example, if the value of the ‘dir’ field is ‘0’, this indicates that the reference block is present in the next frame, and if the value of the ‘dir’ field is ‘1’, this indicates that the reference block is present in the previous frame.

The mode of the macroblock may also be expressed using a mode information field (mode) indicating the direction of each reference block and a number information field (num) indicating the number of reference blocks. For example, if up to two reference blocks are selected, 2 bits are assigned to the ‘mode’ field, and 1 bit is assigned to the ‘num’ field. In this example, a ‘mode’ value of ‘01’ may be set to indicate the backward mode, and a ‘mode’ value of ‘10’ may be set to indicate the forward mode. For each of the two ‘mode’ values ‘01’ and ‘10’, a ‘num’ value of ‘0’ may be set to indicate that one reference block is present, and a ‘num’ value of ‘1’ can be set to indicate that two reference blocks are present. In addition, a ‘mode’ value of ‘00’ and a ‘num’ value of ‘0’ may be set to indicate the skip mode, and a ‘mode’ value of ‘00’ and a ‘num’ value of ‘1’ may be set to indicate the inverse direction mode.

The data stream encoded in the method described above is transmitted by wire or wirelessly to a decoding device or is delivered via recording media. The decoding device restores the original video signal of the encoded data stream according to the method described below.

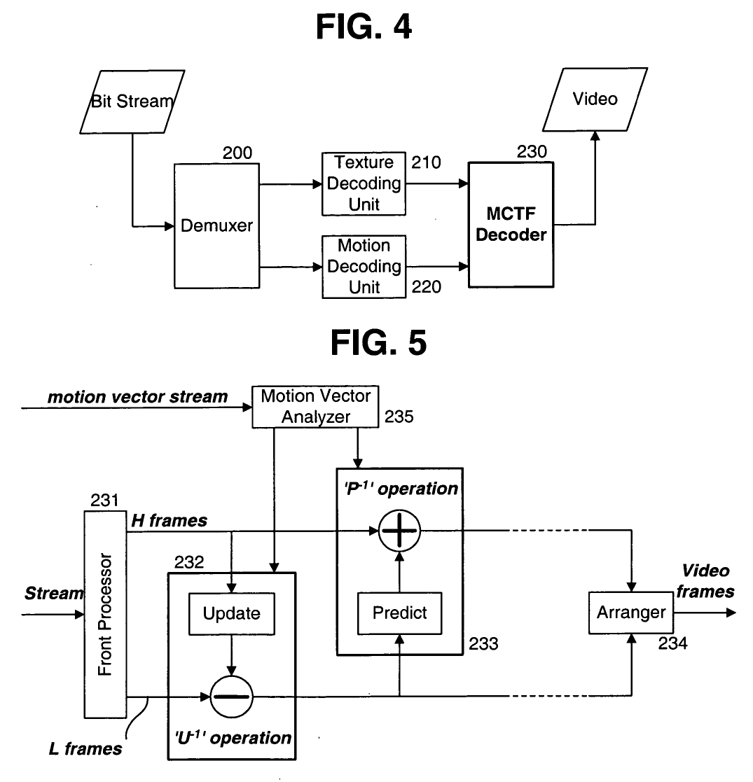

FIG. 4 is a block diagram of a device for decoding a data stream encoded by the device of FIG. 1. The decoding device of FIG. 5 includes a demuxer (or demultiplexer) 200, a texture decoding unit 210, a motion decoding unit 220, and an MCTF decoder 230. The demuxer 200 separates a received data stream into a compressed motion vector stream and a compressed macroblock data stream. The texture decoding unit 210 restores the compressed macroblock information stream to its original uncompressed state. The motion decoding unit 220 restores the compressed motion vector stream to its original uncompressed state. The MCTF decoder 230 converts the uncompressed macroblock information stream and the uncompressed motion vector stream back to an original video signal according to an MCTF scheme.

The MCTF decoder 230 includes, as an internal element, an inverse filter as shown in FIG. 5 for restoring an input stream to its original frame sequence.

The inverse filter of FIG. 5 includes a front processor 231, an inverse updater 232, an inverse predictor 233, an arranger 234, and a motion vector analyzer 235. The front processor 231 divides an input macroblock data stream into H frames and L frames, and analyzes information in the header of each macroblock. The inverse updater 232, as will be described in more detail below, subtracts pixel differences of input H frames from corresponding pixel values of input L frames. The inverse predictor 233, as will be described in more detail below, restores input H frames to frames having original images using the H frames and the L frames from which the image differences of the H frames have been subtracted. The arranger 234 interleaves the frames, completed by the inverse predictor 233, between the L frames output from the inverse updater 232, thereby producing a normal video frame sequence. The motion vector analyzer 235 decodes an input motion vector stream into motion vector information of each block and provides the motion vector information to the inverse updater 232 and the inverse predictor 233. Although one inverse updater 232 and one inverse predictor 233 are illustrated above, a plurality of inverse updaters 232 and a plurality of inverse predictors 233 may be provided upstream of the arranger 234 in multiple stages corresponding to the MCTF encoding levels described above.

The front processor 231 analyzes and divides an input macroblock data stream into an L frame sequence and an H frame sequence. In addition, the front processor 231 uses information in the header of each macroblock in the H frame to notify the inverse updater 232 and the inverse predictor 233 of information (e.g., mode information) of a reference block or blocks that have been used to produce each macroblock in the H frame.

The inverse updater 232 performs the operation of subtracting an image difference of an input H frame from an input L frame in the following manner. For each reference block present in the L frame to which a block mode is assigned, the inverse updater 232 searches for a macroblock in the H frame corresponding to the reference block using mode information received from the front processor 231 and a motion vector received from the motion vector analyzer 235. The inverse updater 232 performs the operation of subtracting the found macroblock in the input H frame from the reference block in the input L frame, thereby restoring an original image of the reference block.

Using the motion vector received from the motion vector analyzer 235 and the mode information received from the front processor 231, the inverse predictor 233 adds pixel values of the reference block or based on the image blocks (e.g., average of the image blocks), from which the image difference of the macroblock in the H frame has been subtracted in the inverse updater 232, to the macroblock in the H frame, thereby restoring an original image of the macroblock in the H frame. Namely, as will be appreciated, the mode information and motion vector(s) provide the information to determined the reference block or blocks for a macroblock in the H frame, and provide the information on how the macroblock was encoded; and therefore, provide the information on how to decode the macroblock.

Macroblocks restored to their original pixel values by the inverse updater 232 are combined to produce a single complete video frame. Likewise, macroblocks restored to their original pixel values by the inverse predictor 233 are combined to produce a single complete video frame.

The above decoding method restores an MCTF-encoded data stream to a complete video frame sequence. In the case where the estimation/prediction and update operations have been performed for a group of pictures (GOP) N times in the MCTF encoding procedure described above, a video frame sequence with the original image quality is obtained if the inverse prediction and update operations are performed N times in the MCTF decoding procedure. However, a video frame sequence with a lower image quality and at a lower bitrate may be obtained if the inverse prediction and update operations are performed less than N times. Accordingly, the decoding device is designed to perform inverse prediction and update operations to the extent suitable for its performance.

The decoding device described above may be incorporated into a mobile communication terminal or the like or into a media player.

As is apparent from the above description, a method for encoding/decoding video signals according to the present invention may assign two reference blocks in one frame to an image block when a video signal is encoded and decoded in a scalable MCTF scheme, thereby reducing the occurrence of unconnected areas and increasing coding gain.

Although the example embodiments of the present invention have been disclosed for illustrative purposes, those skilled in the art will appreciate that various modifications, additions and substitutions are possible, without departing from the scope and spirit of the invention.

1. A method of decoding an encoded video signal including a first frame sequence and a second frame sequence by inverse motion compensated temporal filtering, comprising:
determining one or more macroblocks in at least one frame in the second frame sequence associated with a current macroblock in a current frame in the first frame sequence based on information included in a header of the current macroblock;
decoding the determined one or more macroblocks based on the current macroblock and the information; and
decoding the current macroblock based on the decoded one or more macroblocks.

2. The method of claim 1, wherein each frame in the second frame sequence including one of the determined macroblocks is adjacent to the current frame in the first frame sequence in the decoded video signal.

3. The method of claim 2, wherein the adjacent frame includes one or two macroblocks.

4. The method of claim 1, wherein if the determining step determines, based on the information, that one macroblock in a frame of the second frame sequence is associated with the current macroblock, the frame in the second frame sequence is one of prior to and subsequent to the current frame in the decoded video signal.

5. The method of claim 4, wherein if the determining step determines, based on the information, that first and second macroblocks in at least one frame of the second frame sequence are associated with the current macroblock, the first and second macroblocks are one of (1) both in a frame of the second frame sequence that is prior to the current frame in the decoded video signal, (2) both in a frame of the second frame sequence that is subsequent to the current frame in the decoded video signal, and (3) the first macroblock is in a frame of the second frame sequence that is prior to the current frame in the decoded video signal and the second macroblock is in a frame in the second frame sequence that is subsequent to the current frame in the decoded video signal.

6. The method of claim 5, wherein the information indicates an encoding mode of the current macroblock.

7. The method of claim 5, wherein the information indicates a number of the macroblocks in the second frame sequence associated with the current macroblock, and direction of each macroblock in the second frame second associated with the current macroblock.

8. The method of claim 4, wherein the information indicates an encoding mode of the current macroblock.

9. The method of claim 4, wherein the information indicates a number of the macroblocks in the second frame sequence associated with the current macroblock, and direction of each macroblock in the second frame second associated with the current macroblock.

10. The method of claim 1, wherein if the determining step determines, based on the information, that first and second macroblocks in at least one frame of the second frame sequence are associated with the current macroblock, the first and second macroblocks are one of (1) both in a frame of the second frame sequence that is prior to the current frame in the decoded video signal, (2) both in a frame of the second frame sequence that is subsequent to the current frame in the decoded video signal, and (3) the first macroblock is in a frame of the second frame sequence that is prior to the current frame in the decoded video signal and the second macroblock is in a frame in the second frame sequence that is subsequent to the current frame in the decoded video signal.

11. The method of claim 10, wherein the information indicates an encoding mode of the current macroblock.

12. The method of claim 10, wherein the information indicates a number of the macroblocks in the second frame sequence associated with the current macroblock, and direction of each macroblock in the second frame second associated with the current macroblock.

13. The method of claim 1, wherein the information indicates an encoding mode of the current macroblock.

14. The method of claim 1, wherein the information indicates a number of the macroblocks in the second frame sequence associated with the current macroblock, and direction of each macroblock in the second frame second associated with the current macroblock.

15. The method of claim 1, wherein the decoding the determined one or more macroblocks step includes subtracting the current macroblock from the determined one or more macroblocks.

16. The method of claim 15, wherein, if the determining step determines one macroblock, the decoding the current macroblock step includes adding the decoded determined macroblock to the current macroblock.

17. The method of claim 15, wherein, if the determining step determines more than one macroblock, the decoding the current macroblock step includes adding the current macroblock to an average of the decoded determined macroblocks.

18. The method of claim 1, wherein, if the determining step determines one macroblock, the decoding the current macroblock step includes adding the decoded determined macroblock to the current macroblock.

19. The method of claim 1, wherein, if the determining step determines more than one macroblock, the decoding the current macroblock step includes adding the current macroblock to an average of the decoded determined macroblocks.

20. The method of claim 1, further comprising:
dividing the encoded video signal into the first and second frame sequences.

21. A method of encoding a video signal by motion compensated temporal filtering, comprising:
determining one or more macroblocks in at least one frame adjacent to a frame including a current macroblock;
encoding the current macroblock based on the determined one or more macroblocks to form a first sequence of frames in the encoded video signal;
encoding the determined one or more macroblocks based on the encoded current macroblock to form a second sequence of frames in the encoded video signal; and
adding information to a header of the encoded current macroblock indicating the determined one or more macroblocks associated with the encoded current macroblock.
